(19) United States
(12) Patent Application Publication
(10) Pub. No.: US 2019/0263685 A1
(43) Pub. Date: Aug. 29, 2019

(54) FORMING DILUTED BRINE WITHOUT ADDITION OF SOFT OR CONTAMINATED WATER IN AN OIL AND GAS TREATMENT FACILITY

(71) Applicant: Chevron U.S.A. Inc., San Ramon, CA (US)

(72) Inventors: Nitesh BHUWANIA, Houston, TX (US); Prakhar PRAKASH, Bakersfield, CA (US); Evan Shigeto HATAKEYAMA, Richmond, CA (US); Christopher MARCOTTE, Bakersfield, CA (US)

(21) Appl. No.: 15/905,991

(22) Filed: Feb. 27, 2018

(51) Int. Cl. C02F 1/44; B01D 61/00

(52) U.S. Cl. CPC C02F 1/445; C02F 2103/10; B01D 61/002

(57) ABSTRACT

Processes and systems form diluted brine from saturated brine without direct addition of soft or contaminated water in an oil and/or gas treatment facility. Water containing salt contaminants is fed to a forward osmosis membrane. The salt contaminants can be cations, anions, carbonate, bicarbonate and combinations thereof. A saturated brine solution is fed to a draw side of the forward osmosis membrane which allows water to pass from the feed side to the draw side and minimizes the passage of the salt contaminants from the feed side to the draw side. A diluted brine solution having a TDS concentration lower than a TDS concentration of the saturated brine solution is removed from the draw side outlet of the forward osmosis membrane. A concentrated contaminated water stream having a TDS concentration higher than a TDS concentration of the contaminated water feed is removed from the feed side outlet of the forward osmosis membrane.

### FIELD

The present disclosure relates generally to the field of water treatment, particularly systems and methods using forward osmosis membranes to treat saturated brine in oil and gas production facilities.

### BACKGROUND

Oil and gas production facilities are known to have a variety of water streams present. For every barrel of crude oil produced, about three to ten barrels of water is produced. In the oil and gas industry, water that is drawn from the formation is referred to as “produced water.” Among the variety of water streams present are high salinity brine solutions containing salts such as sodium, calcium or bromides, from such sources as acid treatment units for water softening. In conventional practice, soft water is often used to dilute the high salinity brine solutions. Contaminated wastewater streams are also present resulting from various oil and gas processes and are often used to dilute the high salinity brine solutions. Contaminated wastewater streams can include, for example, pit wastewater (i.e., oily waste waters from various plant operations dumped into a pit) and high fouling and scaling waters (e.g., containing significant amounts of bicarbonates, sulphates, silica, calcium and the like). Most wastewater streams resulting from various processes are sent for disposal. For example, solids removal followed by primary treatment (e.g., dispersed oil removal, suspended solids removal) and secondary treatment (e.g., flotation treatment). In some cases, tertiary treatments (e.g., hardness, dissolved salts) and chemical treatments may also be carried out on the wastewater streams.

There exists a need for more efficient means of using and disposing of both high salinity brine solutions and contaminated wastewater streams in oil and gas production facilities. It would further be desirable to reduce soft water use.

### SUMMARY

In general, in one aspect, the disclosure relates to processes for forming diluted brine from saturated brine without the addition of soft water in an oil and/or gas treatment facility. The processes include feeding a contaminated water feed containing water and salt contaminants from a source of contaminated water to a feed side of a forward osmosis membrane. The salt contaminants can be cations, anions, carbonate, bicarbonate and combinations thereof. a saturated brine solution is fed to a draw side of the forward osmosis membrane and the forward osmosis membrane allows water to pass from the feed side to the draw side and minimizes the passage of the salt contaminants from the feed side to the draw side. a diluted brine solution having a total dissolved solids concentration lower than a total dissolved solids concentration of the saturated brine solution is removed from the draw side outlet of the forward osmosis membrane. a concentrated contaminated water stream having a total dissolved solids concentration higher than a total dissolved solids concentration of the contaminated water feed is removed from the feed side outlet of the forward osmosis membrane.

In another aspect, the disclosure can generally relate to systems for forming the diluted brine from saturated brine without the addition of soft water in an oil and/or gas treatment facility. The system includes a source of the contaminated water, a source of the saturated brine solution, a forward osmosis membrane having a feed side and a draw side, a feed side inlet and a feed side outlet, a draw side inlet and a draw side outlet, wherein the feed side inlet is connected to the source of contaminated water and the draw side inlet is connected to the source of saturated brine solution, and a diluted brine tank connected to the draw side outlet of the forward osmosis membrane for storing diluted brine solution.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 shows a schematic diagram of a water management system according to the prior art.

FIG. 2 shows a schematic diagram of a water management system in which an example embodiment is applied.

FIG. 3 shows a schematic diagram of a water management system in which an example embodiment is applied.

FIGS. 4-11 show plots of water recovery versus time and flux versus water recovery as measured for example embodiments.

FIG. 12 shows a schematic diagram of a water management system according to the prior art.

FIG. 13 shows a schematic diagram of a water management system in which an example embodiment is applied.

### DETAILED DESCRIPTION

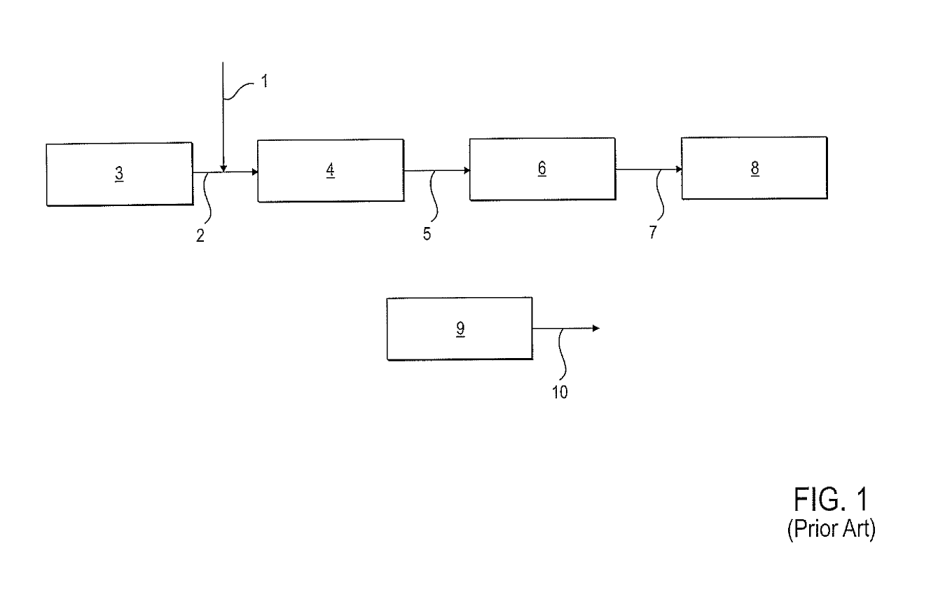

Referring to FIG. 1, a conventional water management system and process for handling saturated brine is shown. Saturated brine solution 2, which can be stored in a saturated brine tank 3, is diluted with soft water 1. The diluted brine solution can then optionally be stored in a diluted brine tank 4. The diluted brine solution 5, also referred to as fresh brine 5, is then sent to an ion exchange unit 6. The ion exchange unit 6 is used to remove hardness by exchanging hardness ions from the brine solution 5 on an ion exchanging resin in the ion exchange unit 6, thus forming a waste brine solution 7. Waste brine 7 can then be disposed of in any of a variety of disposal means 8, including re-injecting the waste brine 7 into a subterranean formation (not shown) or third-party transportation and disposal of the waste brine 7. In a separate location in the system, a wastewater pit 9 stores wastewater from a process, such as an oil and gas processing. Wastewater stream 10 can be subjected to a treatment process or third-party disposal (not shown) or injected into a subterranean formation, as would be known to one of ordinary skill in the art.

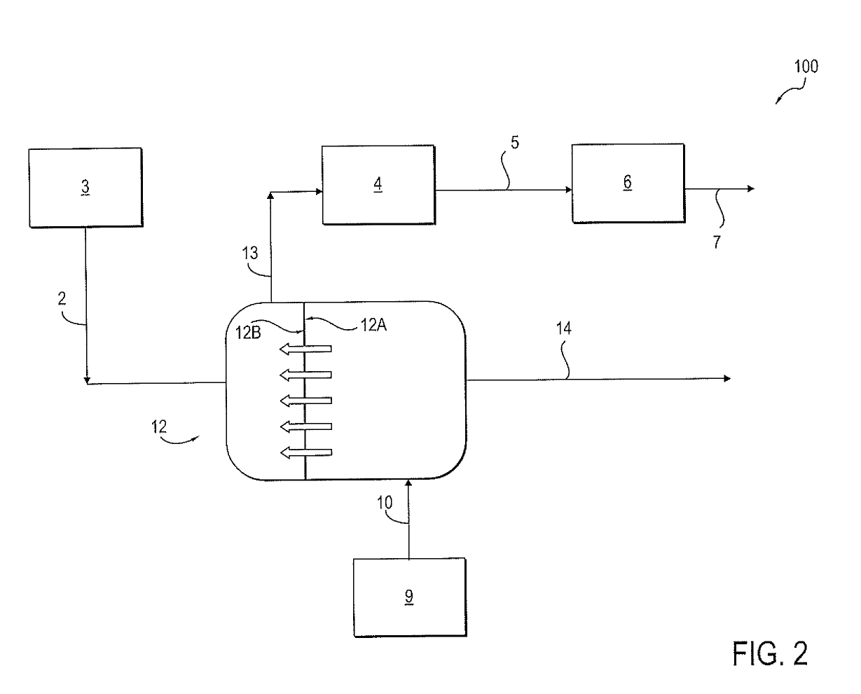

In embodiments, a process and system are provided for forming diluted brine from saturated brine without the use of direct addition of soft water or contaminated water in an oil and/or gas treatment facility. Referring to FIG. 2, a system 100 includes the use of a forward osmosis membrane unit 12, also referred to herein as a forward osmosis membrane 12. As is well known, forward osmosis operates to separate dissolved solutes from water across a semipermeable forward osmosis membrane using the osmotic pressure gradient between a feed solution and a draw solution as the driving force. The forward osmosis membrane has a feed side 12A and a draw side 12B, a feed side inlet 12Aᵢ and a feed side outlet 12Aₒ, a draw side inlet 12Bᵢ and a draw side outlet 12Bₒ.

The feed side inlet 12Aᵢ is connected to a source of contaminated water 9. Wastewater stream 10, also referred to as contaminated water feed 10, from a source of contaminated water 9, e.g., wastewater pit or tank, is fed to the feed side inlet 12Aᵢ of the forward osmosis membrane unit 12. In one embodiment, the wastewater stream 10 can be produced water associated with oil and/or gas production. The wastewater stream 10 can contain various contaminants including, but not limited to, cations e.g. sodium, potassium, magnesium and/or calcium, anions e.g. chloride and/or sulfate, carbonate, bicarbonate and combinations thereof.

The draw side inlet 12Bᵢ is connected to the source of saturated brine solution 3. A saturated brine solution 2 is fed from the saturated brine tank 3 to a draw side 12B of the forward osmosis membrane unit 12. In one embodiment, the wastewater stream 10 has a total dissolved solids concentration (TDS) of from 5,000 to 50,000 mg/L and the saturated brine solution 2 has a TDS of 50,000 to 357,000 mg/L.

Water is drawn from the feed side of the membrane 12A to the draw side of the membrane 12B by osmotic driving force. Water from the wastewater stream 10 moves across the forward osmosis membrane, thereby diluting the saturated brine solution 2 and forming a diluted brine solution stream 13. In one embodiment, from 20 to 95%, even from 90 to 95%, of the water in the wastewater stream 10 passes from the feed side 12A to the draw side 12B and is recovered in the diluted brine solution 13. The forward osmosis membrane 12 minimizes the passage of the contaminants, also referred to as salt contaminants, from the feed side 12A to the draw side 12B.

The diluted brine solution stream 13 having a TDS lower than a TDS of the saturated brine solution 2 is formed without the direct addition of soft water 1 or contaminated water. The diluted brine 13 is removed from the draw side outlet of the forward osmosis membrane 12. The diluted brine 13 can be sent to the diluted brine tank 4 and the ion exchange unit 6 to regenerate the resin bed, as in the conventional water management system described above with respect to FIG. 1, thereby forming waste brine stream 7. In one embodiment, the diluted brine tank 4 is not connected to a source of soft water or contaminated water. In one embodiment, the diluted brine solution stream 13 or waste brine stream 7 can be disposed of in any of a variety of disposal means 8, including re-injecting the waste brine 7 into a subterranean formation or reservoir (not shown) or third-party transportation and disposal. A water injection facility connected to the diluted brine tank can be used for injecting the diluted brine solution into a subterranean reservoir.

A concentrated contaminated water stream 14 having a TDS higher than a TDS of the wastewater stream 10 is removed from the feed side outlet of the forward osmosis membrane 12. In one embodiment, the diluted brine solution 13 has a TDS of from 100,000 to 150,000 mg/L and the concentrated contaminated water stream 14 has a TDS of from 25,000 to 150,000 mg/L. The concentrated contaminated water stream 14 can be treated in a water treatment facility (not shown) connected to the feed side outlet of the forward osmosis membrane 12, or in some cases injected into a subterranean reservoir after moderate treatment. The concentrated contaminated water stream 14 can be treated in the water treatment facility using an evaporator crystallizer, a microfiltration unit, and/or an ultrafiltration unit (not shown).

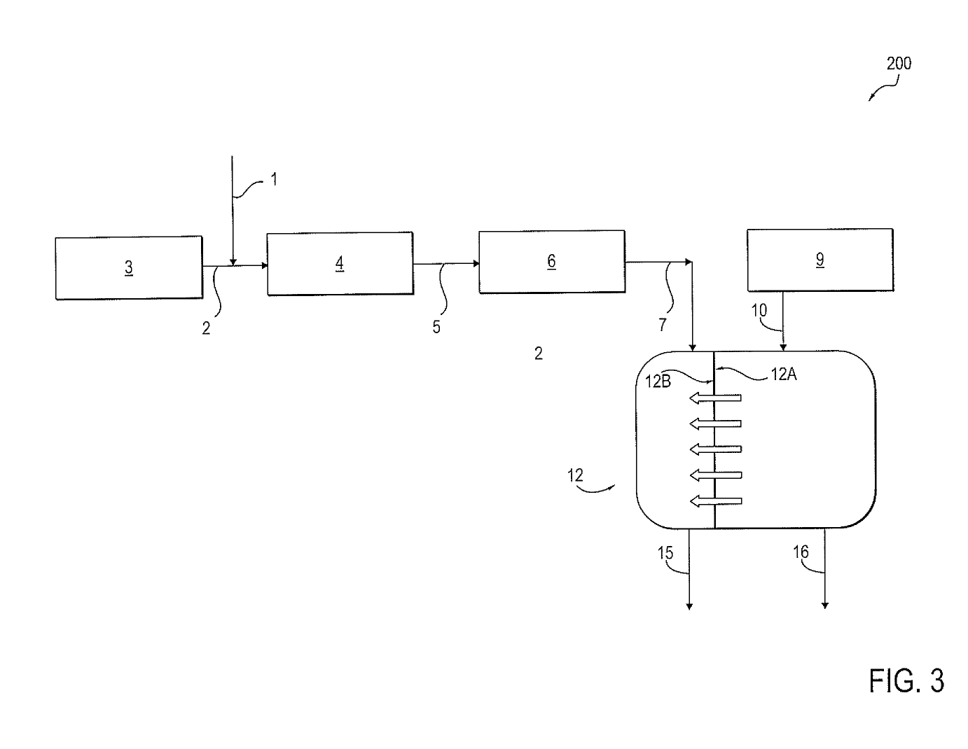

Referring to FIG. 3, other embodiments are disclosed in which soft water 1 is added to saturated brine 2 in a system 200 that also utilizes a forward osmosis membrane 12. As in FIG. 1, saturated brine solution 2 is taken from saturated brine tank 3 and diluted with soft water 1. The diluted brine solution is stored in a diluted brine tank 4. The diluted brine solution 5, also referred to as fresh brine 5, is then sent to an ion exchange unit 6, thereby forming a waste brine solution 7. Waste brine 7 is then sent to the draw side 12B of a forward osmosis membrane 12. A wastewater stream 10 from a source of wastewater 9 is sent to the feed side inlet 12Aᵢ of the forward osmosis membrane 12. Water is drawn from the feed side 12A to the draw side 12B. As a result, a final waste brine stream 15 is formed and removed from the draw side outlet 12Bₒ of the forward osmosis membrane 12. The final waste brine stream 15 can be injected into a subterranean formation or reservoir. A concentrated contaminated water stream 16 is formed and removed from the feed side outlet of the forward osmosis membrane 12.

Referring to FIG. 12, a simplified schematic of a conventional water treatment method according to the prior art is shown in which a produced water stream 17, i.e., water associated with oil and gas production, contains high levels of silica and bicarbonates i.e. containing silica from 50 to 250 mg/l and bicarbonate from 1000 to 3000 mg/l. The produced water stream 17 is diluted by combining with a brine solution 2 in a dilution vessel 18. The diluted stream 20 is then fed to an ion exchange softener vessel 24. Because of the risk of scaling due to reactivity between the softener's hardness and the produced water's silica and alkalinity (bicarbonates), anti-scalant chemicals 19 are added to the spent brine stream 25. The resulting treated stream 26 can be disposed of in a variety of ways, including injection into a subterranean formation.

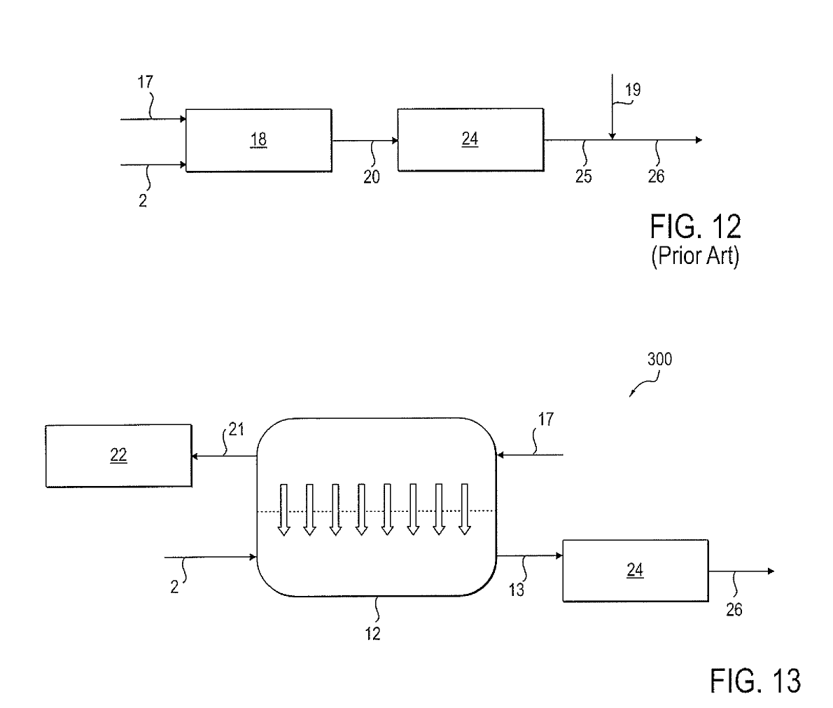

Referring to FIG. 13, according to one embodiment, shown is a schematic of a water treatment system 300 for handling produced water stream 17 containing high levels of silica and bicarbonates that advantageously avoids or minimizes the need for addition of anti-scalant chemicals. The produced water stream 17 is fed to the feed side inlet 12Aᵢ of forward osmosis membrane 12. A saturated brine solution 2 is fed to the draw side inlet 12Bᵢ of the forward osmosis membrane 12. A diluted brine solution stream 13 is removed from the draw side outlet 12Bₒ of the membrane 12. Diluted brine solution stream 13 has a lower scaling potential than stream 25 of FIG. 12. The diluted brine solution 13 can be fed to an ion exchange softener vessel 24, and the resulting treated stream 26 can be disposed of in a variety of ways, including injection into a subterranean formation. A concentrated contaminated water stream 21 is removed from the feed side outlet 12Aₒ of the membrane 12 and sent to waste disposal 22. Waste disposal 22 can include an evaporator crystallizer or filter (microfiltration or ultrafiltration) at a surface location.

### EXAMPLES

### Example 1

A process using system 100 shown in FIG. 2 was run using forward osmosis membranes 12 from two different membrane vendors, referred to as the first membrane and the second membrane. The first membrane had a plate and frame configuration and had an average membrane flux at different draw concentrations of 10 liters/m²/hour (lmh). The second membrane had a spiral wound configuration and had an average membrane flux at different draw concentrations of 4.5 lmh.

A membrane coupon was placed in a forward osmosis membrane module with connections for feed water inlet and outlet on one side and draw water inlet and outlet on the other side. The produced water (pit wastewater; stream 10 from facility 9 in FIG. 2) was feed into the FO membrane 12 at a fixed flow rate and ambient pressure. Similarly, the saturated brine was used as a draw solution inlet (stream 2 in FIG. 2) To demonstrate at lab scale, a fixed volume of both the feed and draw solutions was used. Both the feed and draw water tanks were placed on a weighing scale, so that constant weight increase was monitored to obtain the desired water recovery levels. A minimum of 38% water recovery from feed to draw side was desired and also was demonstrated because that matches with the level of soft water which was being added to dilute the saturated brine in the process FIG. 1. Hence by having a targeted water recovery of 38% from the pit wastewater (stream 10 in FIG. 2) using the forward osmosis membrane, the need to add use of soft water was eliminated.

The flow rates and TDS of the streams 2, 5, 7, 10, and 14 are listed in Table 1. The components detected in the streams 2, 13, 10 and 14 are listed in Table 2.

TABLE 1

| | Flow rate in barrels of | TDS in mg per |
|---|---|---|
| Stream | water per day (bwpd) | liter (mg/L NaCl) |
| Saturated brine 2 | 500 | 250,000 |
| Fresh brine 5 | 1000 | 125,000 |
| Waste brine 7 | 1000 | 125,000 |
| Wastewater 10 | 2000 | 10,000 |
| Concentrated | 1250 | 30,000 |
| contaminated water 14 | | |

TABLE 2

| | Feed | Feed | Draw | Draw |
|---|---|---|---|---|
| | side in | side out | side in | side out |
| | (stream 10) | (stream 14) | (stream 2) | (stream 13) |
| | (TDS | (TDS | (TDS | (TDS |
| Components | in mg/L) | in mg/L) | in mg/L) | in mg/L) |
| Boron (B) | 98.6 | 173 | 0.95 | 37.6 |
| Calcium (Ca) | 133 | 31.4 | 51.7 | 19.3 |
| Potassium (K) | 137 | 218 | 71.7 | 105 |
| Magnesium | 33.2 | 65.2 | 23.5 | 8.49 |
| (Mg) | | | | |
| Silica (Si) | 66.1 | 75.1 | 2.4 | 3.81 |
| Sulphate (SO₄) | 691 | 883 | 160 | 65 |
| Carbonate (CO₃) | 1200 | 1800 | N/D | N/D |

As a result of the forward osmosis membrane treatment, a sample of the fresh brine stream 5 was visually clear and clean.

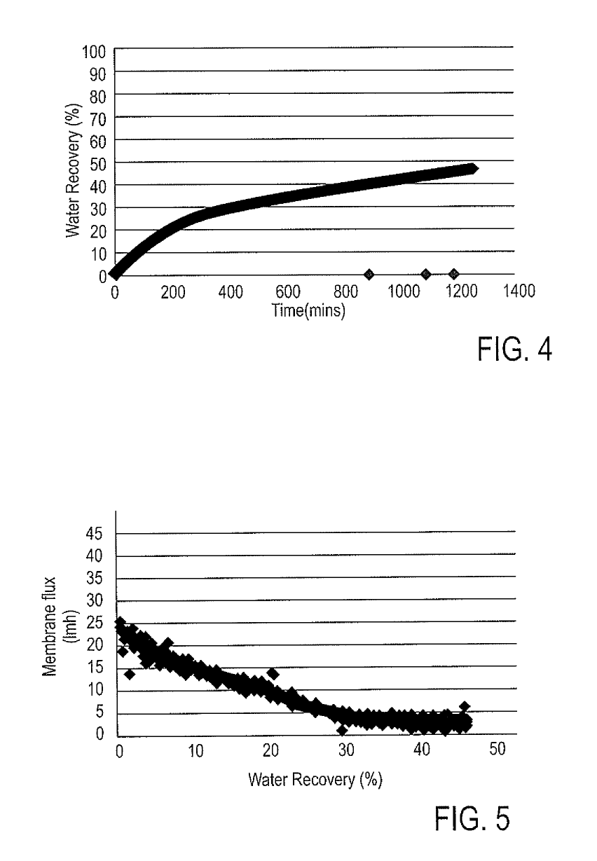

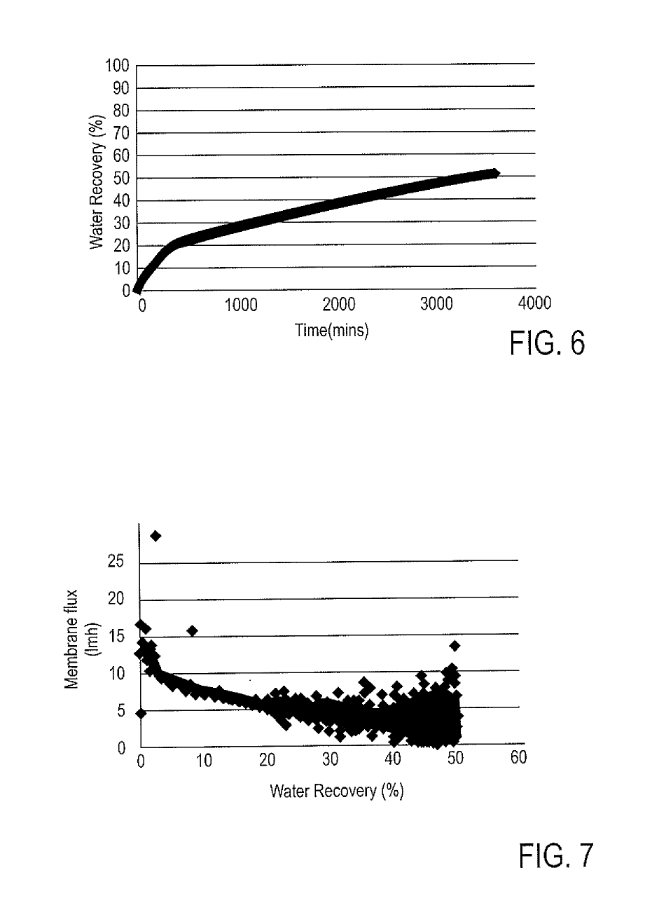

FIG. 4 is a plot of water recovery (%) vs. time obtained using the first membrane in the lab demonstration for the FIG. 2 process scheme. The water recovery in this plot is the amount of water recovered from the feed side of the forward osmosis membrane on to the draw side driven by the osmotic pressure difference. As can be seen, the targeted 38% water recovery was achieved after about 650 mins after starting the feed/draw flow on both sides of the membrane. FIG. 5 is a plot of membrane flux (lmh) vs. water recovery obtained using the first membrane. By membrane flux is meant the volumetric rate of water transferring across the membrane normalized by the membrane surface area. As can be seen, the membrane flux at initial recoveries was high (about 25 lmh) and started to drop and stabilize at a lower value of about 5 lmh; this is because a batch process was used in this lab demonstration. Hence, there was a constant change in the osmotic pressure driving force of the membrane, i.e. the driving force was highest with fresh/saturated brine (highest TDS concentration) and as the soft water continued to dilute the brine, TDS concentration values started dropping, i.e. the osmotic pressure for separation also dropped. Likewise, FIGS. 6 and 7 are plots of water recovery vs. time and membrane flux vs. water recovery, respectively, using the second membrane. Similar to the first membrane, the second membrane also showed the ability to reach the targeted 38% water recovery after about 1900 mins. The major difference between the first membrane results (FIG. 5) and second membrane results (FIG. 7) are the membrane flux values, due to differences in the two membranes' compositions.

### Example 2

A process using system 200 shown in FIG. 3 was run using the first membrane and the second membrane as used in Example 1. The first membrane had a plate and frame configuration and had an average membrane flux at different draw concentrations of 10 liters/m²/hour (lmh). The second membrane had a spiral wound configuration and had an average membrane flux at different draw concentrations of 4.5 lmh.

A membrane coupon was placed in a forward osmosis membrane module with connections for feed water inlet and outlet on one side and draw water inlet and outlet on the other side. The produced water containing oily sludge (stream 10 from facility 9 in FIG. 3) was fed into the FO membrane 12 at a fixed flow-rate and ambient pressure. No pretreatment of stream 10 was conducted. Similarly, the saturated brine was used as a draw solution inlet (stream 7 in FIG. 2). To run the experiment at lab scale, a fixed volume of both the feed and draw solutions was used. Both the feed and draw water tanks were placed on a weighing scale, so that constant weight increase could be monitored to obtain the desired water recovery levels. A water recovery of 75% from feed to draw side was demonstrated which is attractive to reduce wastewater disposal. Hence by having a water recovery of 75% from the pit wastewater (stream 10 in FIG. 3) using the forward osmosis membrane, only 25% of concentrated wastewater stream needed further treatment and disposal. In this application, the major driver for water treatment was to minimize the disposal volume of wastewater stream 16 in FIG. 13.

The flow rates and TDS of the streams 2, 5, 7, 10, and 14 are listed in Table 3. The components detected in the streams 10, 16, 7 and 15 are listed in Table 4.

TABLE 3

| | Flow rate in barrels of | TDS in mg per |
|---|---|---|
| Stream | water per day (bwpd) | liter (mg/L NaCl) |
| Saturated brine 2 | 500 | 250,000 |
| Soft water | 500 | n/a |
| Fresh brine 5 | 1000 | 125,000 |
| Waste brine 7 | 1000 | 125,000 |
| Wastewater 10 | 2000 | 8,900 |
| Concentrated contaminated | 500 | 24,800 |
| water 16 | | |
| Final waste brine 15 | 2500 | 65,100 |

TABLE 4

| | | | Draw | Draw |
|---|---|---|---|---|
| | Feed side in | Feed side out | side in | side out |
| | (stream 10) | (stream 16) | (stream 7) | (stream 15) |
| | (TDS | (TDS | (TDS | (TDS |
| Components | in mg/L) | in mg/L) | in mg/L) | in mg/L) |
| Boron (B) | 98.6 | 193 | 0.95 | 27 |
| Calcium (Ca) | 133 | 40 | 51.7 | 18.5 |
| Potassium (K) | 137 | 265 | 71.7 | 70 |
| Magnesium | 33.2 | 85 | 23.5 | 8.1 |
| (Mg) | | | | |
| Silica (Si) | 66.1 | 72 | 2.4 | 3.8 |
| Sulphate (SO₄) | 691 | 870 | 160 | 69 |
| Carbonate (CO₃) | 1200 | 2400 | N/D | N/D |

As a result of the forward osmosis membrane treatment, a sample of the final diluted waste brine 15 obtained from the lab experiments was clear in color.

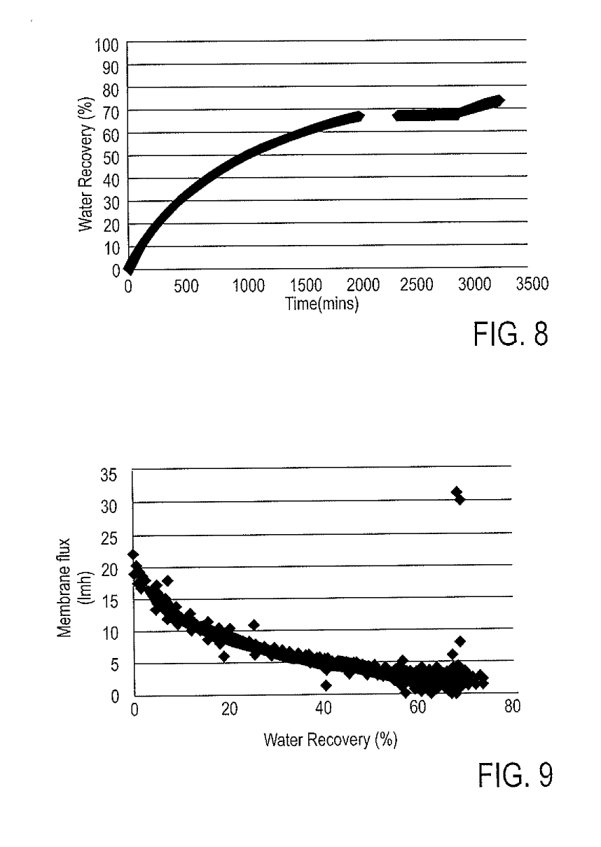

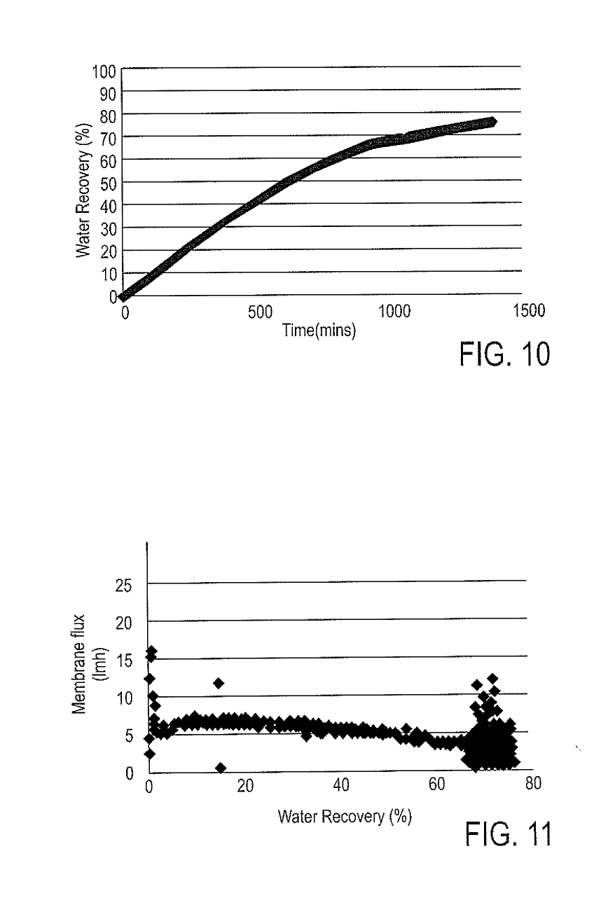

FIG. 8 is a plot of water recovery vs. time obtained using the first membrane in the lab demonstration for the FIG. 3 process scheme. The 75% water recovery was achieved after about 3250 mins of starting the feed/draw flow on both sides of the membrane. FIG. 9 is a plot of membrane flux (lmh) vs. water recovery obtained using the first membrane. As can be seen, the membrane flux at initial recoveries were high (about 20 lmh) and then dropped and stabilized at a lower value of about 3 lmh, due to the use of a batch process in the lab set-up. Hence, there was constant change in the osmotic pressure driving force of the membrane, i.e. the driving force was highest with fresh/saturated brine (highest TDS concentration) and as the soft water continued to dilute the brine, TDS concentration values started dropping, i.e. the osmotic pressure for separation also dropped. Likewise, FIGS. 10 and 11 are plots of water recovery vs. time and membrane flux vs. water recovery, respectively, using the second membrane. Similar to the first membrane, the second membrane also showed the ability to reach the 75% water recovery after about 1300 mins. The major difference between the first membrane results (FIG. 5) and second membrane results (FIG. 7) are the membrane flux values, due to the difference in the two membranes' compositions.

### Example 3

A process using system 300 shown in FIG. 13 was run using the first forward osmosis membrane as used in Examples 1 and 2.

A produced water stream 17 containing high levels of silica (about 210 mg/l) and bicarbonates (about 1400 mg/l) was fed to the feed side inlet of forward osmosis membrane 12. A saturated brine solution 2 was fed to the draw side inlet of the forward osmosis membrane 12. A diluted brine solution stream 13 was removed from the draw side outlet of the membrane 12. Diluted brine solution stream 13 has greatly reduced levels of silica and bicarbonates, and therefore has a low scaling potential. The diluted brine solution 13 can be fed to an ion exchange softener vessel 24 without concern for scale formation and without the need for any anti-scalant chemicals like stream 19 in FIG. 12.

TABLE 5

| Stream | Bicarbonate (mg/L) | Silica (mg/L) |
|---|---|---|
| produced water 17 | 1400 | 210 |
| concentrated contaminated | 4800 | 110 |
| water 21 | | |
| saturated brine solution 2 | 1400 | 110 |
| diluted brine solution 13 | 450 | 26 |

Using the systems and methods of the present disclosure, direct dilution of saturated brine solution using soft or saturated brine solution is avoided. The dilution of the of saturated brine solution is instead accomplished using an FO membrane. That advantageously leads to lowered concentration of potential scalants in the diluted brine.

It should be noted that only the components relevant to the disclosure are shown in the figures, and that many other components normally part of a water treatment system are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. A process for forming diluted brine from saturated brine without the direct addition of soft water in an oil and/or gas treatment facility, comprising:
a. feeding a contaminated water feed comprising water and salt contaminants selected from the group consisting of cations, anions, carbonate, bicarbonate and combinations thereof from a source of contaminated water to a feed side of a forward osmosis membrane;
b. feeding a saturated brine solution to a draw side of the forward osmosis membrane wherein the forward osmosis membrane allows water to pass from the feed side to the draw side and the forward osmosis membrane minimizes passage of the salt contaminants from the feed side to the draw side;
c. removing a diluted brine solution having a total dissolved solids concentration lower than a total dissolved solids concentration of the saturated brine solution from the draw side outlet of the forward osmosis membrane wherein no soft water or contaminated water is added to the diluted brine solution; and
d. removing a concentrated contaminated water stream having a total dissolved solids concentration higher than a total dissolved solids concentration of the contaminated water feed from the feed side outlet of the forward osmosis membrane.

2. The process of claim 1 wherein the contaminated water feed has a total dissolved solids concentration of 5000 to 50,000 mg/L and the saturated brine solution has a total dissolved solids concentration of 50,000 to 357,000 mg/L.

3. The process of claim 1 wherein the diluted brine solution has a total dissolved solids concentration of 100,000 to 150,000 mg/L and the concentrated contaminated water stream has a total dissolved solids concentration of 25,000 to 150,000 mg/L.

4. The process of claim 1 wherein from 20 to 95% of the water in the contaminated water feed passes from the feed side to the draw side of the forward osmosis membrane and is recovered in the diluted brine solution.

5. The process of claim 1 wherein from 90 to 95% of the water in the contaminated water feed passes from the feed side to the draw side of the forward osmosis membrane and is recovered in the diluted brine solution.

6. The process of claim 1 wherein the cations comprise sodium, potassium, magnesium and/or calcium and the anions comprise chloride and/or sulfate.

7. The process of claim 1 wherein the contaminated water feed is a wastewater feed from a source of wastewater.

8. The process of claim 7 wherein the source of wastewater comprises a tank or a pit.

9. The process of claim 7 wherein the source of contaminated water is a source of produced water associated with oil and/or gas production.

10. The process of claim 1 wherein the contaminated water feed is a produced water feed from a source of produced water associated with oil and/or gas production.

11. The process of claim 10 further comprising treating the concentrated contaminated water stream in a water treatment facility connected to the feed side outlet of the forward osmosis membrane.

12. The process of claim 11 wherein the concentrated contaminated water stream is treated using an evaporator crystallizer, a microfiltration unit, and/or an ultrafiltration unit.

13. The process of claim 1 further comprising injecting the diluted brine solution into a subterranean reservoir.

14. The process of claim 1 further comprising recycling the diluted brine solution to a front end of the process upstream of the feed side of the forward osmosis membrane.

15. The process of claim 1 further comprising treating the diluted brine solution.

16. The process of claim 1 further comprising regenerating a resin bed in an ion exchange unit with the diluted brine solution.

17. The process of claim 1 wherein the contaminated water feed comprises greater than 200 mg/L silica and greater than 1400 mg/L bicarbonates, and the diluted brine solution comprises less than 110 mg/L silica and less than 1400 mg/L bicarbonates, and no antiscalant chemical is added to the diluted brine solution.

18. A system for forming diluted brine from saturated brine without the addition of soft water in an oil and/or gas treatment facility, comprising:
a. a source of contaminated water wherein the contaminated water comprises water and salt contaminants selected from the group consisting of cations, anions, carbonate, bicarbonate and combinations thereof;
b. a source of saturated brine solution;
c. a forward osmosis membrane having a feed side and a draw side, a feed side inlet and a feed side outlet, a draw side inlet and a draw side outlet, wherein the feed side inlet is connected to the source of contaminated water and the draw side inlet is connected to the source of saturated brine solution; and
d. a diluted brine tank connected to the draw side outlet of the forward osmosis membrane for storing diluted brine solution wherein the diluted brine tank is not connected to a source of soft water or contaminated water.

19. The system of claim 18 wherein the contaminated water has a total dissolved solids concentration of 5000 to 50,000 mg/L and the saturated brine solution has a total dissolved solids concentration of 50,000 to 357,000 mg/L.

20. The system of claim 18 wherein the diluted brine solution has a total dissolved solids concentration of 100,000 to 150,000 mg/L and the concentrated contaminated water stream has a total dissolved solids concentration of 25,000 to 150,000 mg/L.

21. The system of claim 18 wherein the source of contaminated water is a wastewater storage container comprising a tank or a pit.

22. The system of claim 18 wherein the source of contaminated water is a source of produced water associated with oil and/or gas production.

23. The system of claim 18 further comprising a water treatment facility connected to the feed side outlet of the forward osmosis membrane for treating a concentrated produced water.

24. The system of claim 18 further comprising a water injection facility connected to the diluted brine tank for injecting the diluted brine solution into a subterranean reservoir.
